(19) United States
(12) Patent Application Publication
(10) Pub. No.: US 2022/0417357 A1
(43) Pub. Date: Dec. 29, 2022

(54) MONITORING AND CORRECTING USER INTERFACE ELEMENTS FOR DISPLAY ON A MOBILE DEVICE

(71) Applicant: Amazon Technologies, Inc., Seattle, WA (US)

(72) Inventors: Wei Zhou, San Ramon, CA (US); Sean Janis, Danville, CA (US)

(73) Assignee: Amazon Technologies, Inc., Seattle, WA (US)

(21) Appl. No.: 17/357,657

(22) Filed: Jun. 24, 2021

(51) Int. Cl. H04M 1/72454; G06F 3/0481; H04M 1/72469

(52) U.S. Cl. CPC H04M 1/72454; G06F 3/0481; H04M 1/72469

(57) ABSTRACT

Applications on a mobile device, such as a mobile phone, sometimes enter an incorrect mode of operation wherein the correct user interface elements are not displayed. In order to ensure correct operation of the mobile device, the application can periodically transmit a state of the user interface elements being displayed to a cloud monitoring service that analyzes the state and compares it to a known state that should be displayed. If there is a discrepancy between the state of the mobile device according to the cloud monitoring service and the actual state captured by the mobile device, then the cloud monitoring service can transmit an action to perform by the application on the mobile device to correct the display of the user interface elements.

### BACKGROUND

Mobile or portable devices have become increasingly popular and prevalent in today's society. Many users utilize a mobile device, such as a mobile phone, as their primary means of communication. Mobile devices can include multiple functions, such as cellular phone service, voice over Internet protocol (“VoIP”), software applications, email access, Internet capabilities, calendar functions, music players and the like. Functions, features and capabilities have increased both the utility and complexity of mobile devices.

A graphical user interface (GUI) is a part of a mobile device used for manipulating and controlling functionality. The GUI typically starts with a default screen (also called a home screen or start screen), which includes a plurality of icons. Each icon is a graphic symbol that represents an application, command or data file that can be launched or opened upon selection of the icon. When an application is launched, the application displays content associated with the application and user interface elements, which are selectable (also called “clickable”) by the user, such as links, buttons, menu items, etc. The user interface elements allow the user to manipulate the application to control functionality.

Selection of user interface elements can result in the display of different pages of the application, and those pages might have different user interface elements from other pages. Additionally, if a user scrolls on a page, the user interface elements can change. Sometimes, the application can get into a state where the wrong user interface elements are displayed, or user interface elements that are supposed to be displayed are missing. In such a case, there is little a user can do to correct the situation except closing and restarting the application.

### BRIEF DESCRIPTION OF THE DRAWINGS

FIG. 1 is a system diagram, according to a first embodiment, for monitoring and correcting user interface elements on a mobile device.

FIG. 2 is a system diagram, according to a second embodiment, for monitoring and correcting user interface elements on a mobile device.

FIG. 3 shows a flow diagram according to one embodiment showing interactions between the system components of the system of FIG. 2.

FIG. 4 is an example system diagram showing a plurality of virtual machine instances running in the multi-tenant environment, with backend services from FIG. 1 shown in the multi-tenant environment.

FIG. 5 is a flow diagram according to one embodiment for monitoring and correcting what is displayed on a user interface.

FIG. 6 is a flow diagram according to another embodiment for monitoring and correcting what is displayed on a user interface

FIG. 7 depicts a generalized example of a suitable computing environment in which the described innovations may be implemented.

FIG. 8 is an example user interface including an assistance button to request a refresh of the user interface.

### DETAILED DESCRIPTION

Applications on a mobile device, such as a mobile phone, sometimes enter an incorrect mode of operation wherein the correct user interface elements are not displayed. In order to ensure correct operation of the mobile device, the application can periodically transmit a state of the user interface elements being displayed to a cloud monitoring service that analyzes the state and compares it to a known state that should be displayed. If there is a discrepancy between the state of the mobile device according to the cloud monitoring service and the actual state captured by the mobile device, then the cloud monitoring service can transmit an action to perform by the application on the mobile device to correct the display of the user interface elements.

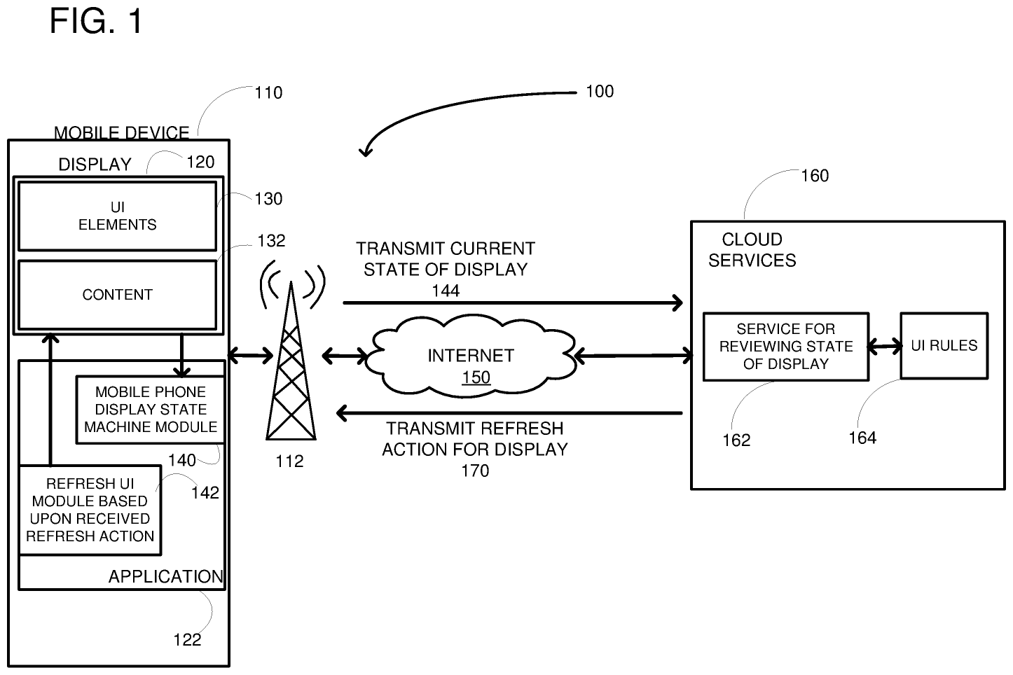

FIG. 1 shows a first embodiment of a system 100 for monitoring and correcting user interface elements on a mobile device 110. The mobile device 110 can be any of a variety of battery-powered computing devices (e.g., cell phone, smartphone, handheld computer, Personal Digital Assistant (PDA), etc.) and can allow wireless two-way communications with one or more mobile communications networks, such as a cellular or satellite network 112. The mobile device 110 includes a display 120 that typically displays icons for launching applications when on a home screen. However, as illustrated in FIG. 1, an application 122 is executing and displaying a combination of UI elements 130 and content 132. The UI elements 130 are selectable by a user, and include such items as links, buttons, menu items, etc., while the content 132 is merely informational (e.g., text, pictures, etc.). The application 122 further includes a mobile phone display state machine module 140. The module 140 can capture a state of which UI elements are currently being displayed to the user. The application 122 can further include a refresh UI module 142 that can refresh the UI elements based upon a received action, as further described below. Periodically (e.g., every 1 minute), the module 140 captures the state of the UI elements currently being displayed and transmits the UI elements, as shown at 144, via the cellular network 112 over the Internet 150 to a cloud service provider 160. The cloud service provider 160 includes a service 162 for reviewing the state information 144 and applying UI rules 164 to the state information to determine what the state of the UI elements should be. For example, the service 162 can determine whether UI elements that should be displayed are missing or can determine that UI elements that are displayed should not be displayed. Additionally, based upon location, potential UI elements that could be displayed but that are not due to other factors, such as that the UI elements are disabled, can be flagged. In any event, based upon its determination, the service 162 can transmit an action 170 to be acted upon by the refresh UI module 142, which can update the UI elements accordingly. In a simple example, the action 170 can be to add a UI display element 120 to the display. In another example, the action can be to display a button that the user can select to refresh the display 120. In another example, the refresh UI module 142 can alert the user to UI elements that are disabled or can automatically enable the UI elements to force the activation thereof.

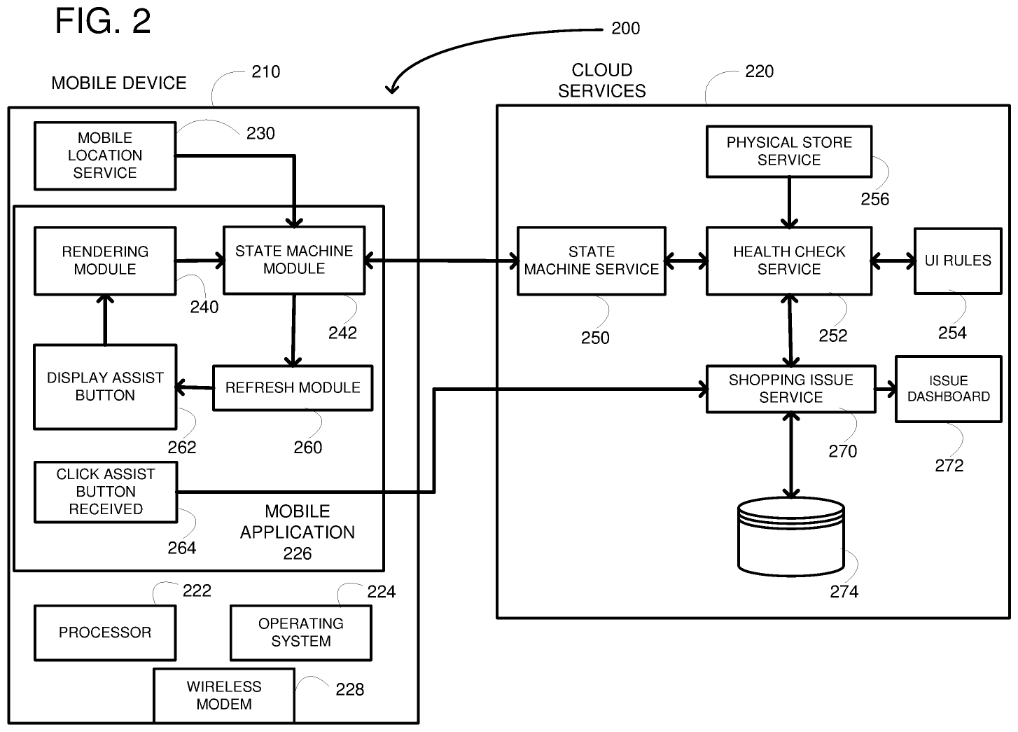

FIG. 2 shows an embodiment of a system 200 for monitoring and correcting user interface elements on a mobile device 210 using a backend cloud service provider 220. The mobile device 210 includes a controller or processor 222 (e.g., signal processor, microprocessor, ASIC, or other control and processing logic circuitry) for performing such tasks as signal coding, data processing, input/output processing, power control, and/or other functions. An operating system 224 can control the allocation and usage of hardware on the mobile device 210 and support for one or more application programs, such as application program 226. The application programs can include common mobile computing applications (e.g., email applications, calendars, contact managers, web browsers, messaging applications, shopping applications, etc.), or any other computing application. A wireless modem 228 can be coupled to an antenna (not shown) and can support two-way communications between the processor 222 and external devices. The modem 228 is shown generically and can include a cellular modem for communicating with a mobile communication network and/or other radio-based modems (e.g., Bluetooth or Wi-Fi). The wireless modem 228 is typically configured for communication with one or more cellular networks, such as a GSM network for data and voice communications within a single cellular network, between cellular networks, or between the mobile device and a public switched telephone network (PSTN). A mobile location service 230 can include a satellite navigation system receiver, such as a Global Positioning System (GPS) receiver or a wi-fi receiver to provide latitude and longitude information or other location information to the mobile application 226. The mobile application 226 can include a rendering module 240 that interacts with a display (not shown) to display content and UI elements associated with the mobile application 226. The rendering module 240 can also be positioned outside of the mobile application 226. A state machine module 242 receives inputs from the rendering module 240 related to what content and UI elements are currently being displayed for the mobile application. Additionally, the state machine module 242 can receive location coordinates, such as longitude and latitude information, from the mobile location service 230. Additional information can relate to what page in the application the user is viewing and where the user is on the page in terms of scrolling, called a scroll height. The state machine module 242 can capture such state information at periodic intervals (e.g., every 20 seconds) so that the state of the mobile device 210 and the state of the mobile application 226 are captured. At the same time interval or a different time interval, the state machine module 242 can communicate with a state machine service 250 in the cloud service provider 220. The state machine service 250 transmits the received state information to a health check service 252 that checks whether the current state of the mobile application 226 complies with UI rules 254. For example, the health check service 252 performs a comparison between the UI elements actually being displayed by the mobile application 226 and the UI elements that are supposed to be displayed in accordance with the UI rules 254. In some cases, the UI rules incorporate the location information, such as the longitude and latitude information. In particular, a physical store service 256 provides longitude and latitude information associated with stores of interest. If the mobile device 210 is within a store of interest (or within a predetermined distance from the store (e.g., 100 meters)), then the UI elements can change for the mobile application 226. Thus, the health check service 252 compares the coordinates of the mobile device 210 with the coordinates of the physical stores identified by the physical store service 256, and if the coordinates match, then the desired UI elements should be displayed in accordance with the UI rules. In some examples, the UI elements associated with the mobile application can change to a Quick Response (QR) code being displayed to check into the store. In other examples, the UI rules 254 can relate to a scrolling height of the application, which is compared to an actual scrolling height captured by the state machine module 242.

In the event that the health check service 252 detects a discrepancy between the UI rules 254 and what is being displayed by the mobile application 226, then corrective action is taken. For example, the health check service 252 directs the state machine service 250 of an action that can be taken, such as forcing a UI element to be displayed. The state machine module 242 receives the action from the state machine service 250 and directs a refresh module 260, which is part of the mobile application, to update the display on the mobile device 210. In one example, a display assist button 262 is displayed that allows a user to update their display if the user detects an error condition. For example, if a checkout UI element is not displayed or if the QR code is not displayed, the user can click the display assist button as shown at 264. As a result of the receipt of the click 264 of the button, the shopping issue service 270 receives a request for assistance as indicated by the arrow between the click assist button received 264 and the shopping issue service 270. The shopping issue service 270 can then take a variety of actions including updating an issue dashboard 272, logging an error event in database 274, or directing the health check service 252 of a corrective action to take, such as directing the state machine module 242 of a particular UI element to display.

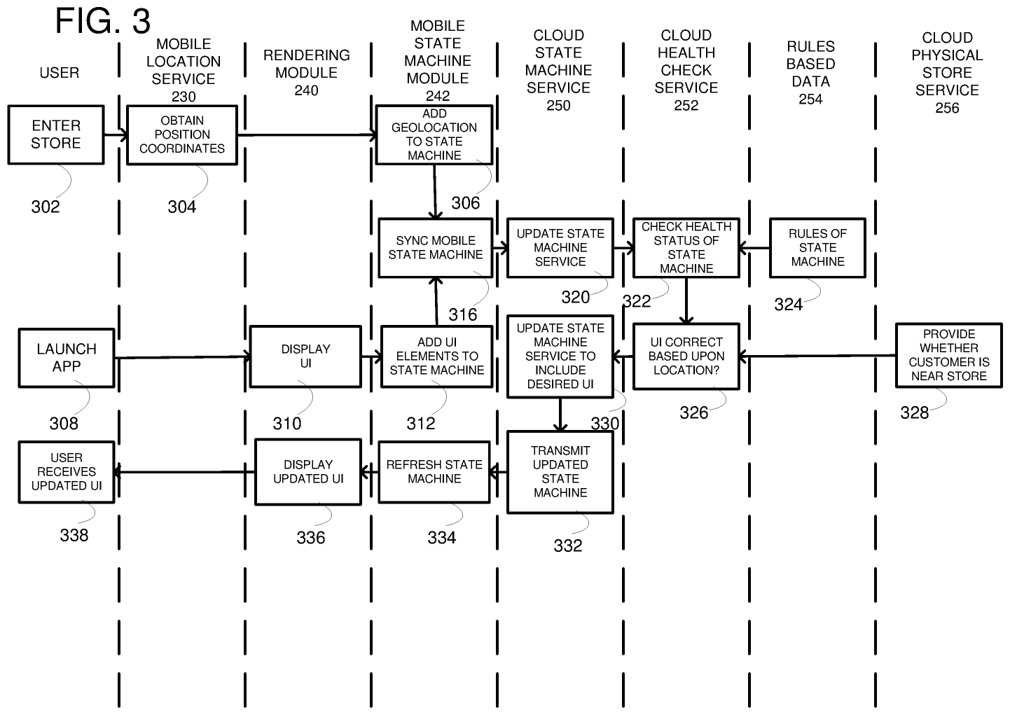

FIG. 3 shows a communication flow between the components of FIG. 2. At 302, a user enters a store. At 304, the mobile location service 230 obtains current coordinates for the mobile device 210 and passes the coordinates to the state machine module 242 at 306. At 308, the user launches the application 226 and at 310, the rendering module 240 displays the UI including the UI elements. At 312, the state machine module adds the UI elements to the state machine. At 316, the mobile state machine obtains a latest update of the UI elements being displayed and other data needed (such as the geolocation of the mobile device or the scrolling height) to obtain the current state of the application 226 on the mobile device. At 320, the state machine service 252 receives the synchronized data from the state machine module 242. At 322, the health check service 352 performs a check of the UI elements displayed by the application 226 by using the rules-based data 254 as shown at 324. In particular, the rules-based data provides a desired state of the UI elements on the display of the mobile device 210. Included in the rules is a check by the health check service 252 whether the UI elements are correct based on a store location. Thus, as shown at 326, the health check service 252 receives data related to store locations as shown at 328. A simple comparison is made between the latitude and longitude coordinates supplied by the mobile location service 230 and the latitude and longitude coordinates of the stores provided by the physical store service 256. If the coordinates are equal or less than a threshold amount apart, then the UI elements are defined in the rules 324 as being associated with the store, which can differ than if the user is not near or in a store. At 330, the health check service 252 instructs the state machine service 250 to take an action, which in this case is to include a desired UI element. At 332, the action is transmitted to the mobile state machine 242. At 334, the state machine module 242 performs a refresh of the state machine and transmits the desired updated UI elements to the rendering module 240 at 336. At 338, the user receives the updated UI.

Thus, the UI is monitored locally in the mobile device 210 and a state of the UI is transmitted to a backend server computer, which checks if the UI is correct and, if necessary, transmits a correction back to the mobile device that can update the UI accordingly.

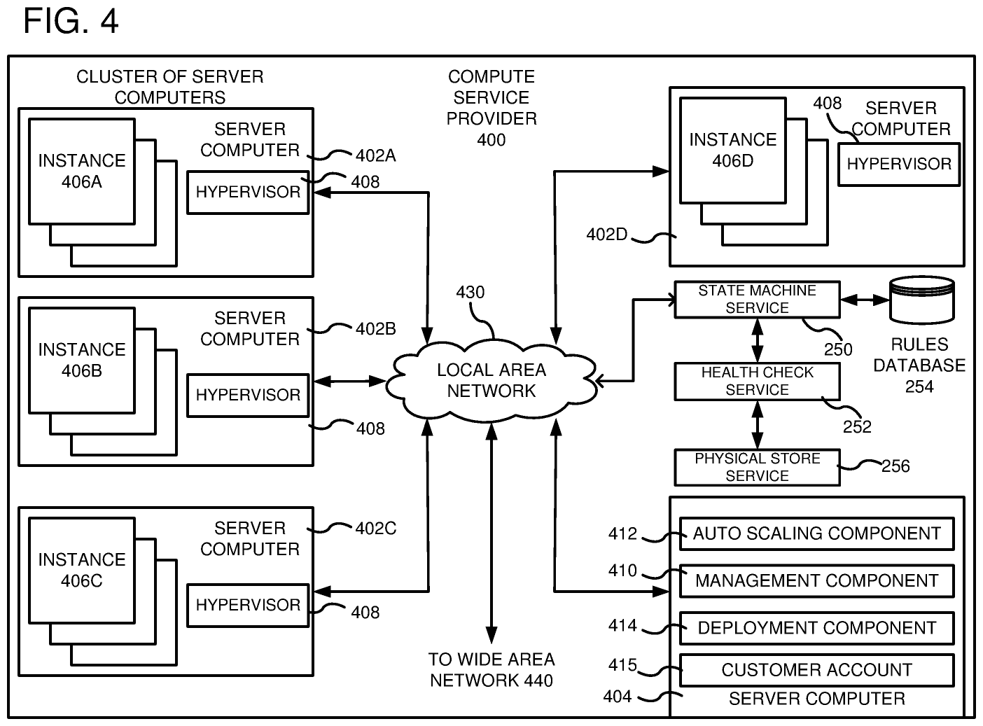

FIG. 4 is a computing system diagram of a network-based compute service provider 400 that illustrates one environment in which embodiments described herein can be used. By way of background, the compute service provider 400 (i.e., the cloud provider) is capable of delivery of computing and storage capacity as a service to a community of end recipients. In an example embodiment, the compute service provider can be established for an organization by or on behalf of the organization. That is, the compute service provider 400 may offer a “private cloud environment.” In another embodiment, the compute service provider 400 supports a multi-tenant environment, wherein a plurality of customers operate independently (i.e., a public cloud environment). Generally speaking, the compute service provider 400 can provide the following models: Infrastructure as a Service (“IaaS”), Platform as a Service (“PaaS”), and/or Software as a Service (“SaaS”). Other models can be provided. For the IaaS model, the compute service provider 400 can offer computers as physical or virtual machines and other resources. The virtual machines can be run as guests by a hypervisor, as described further below. The PaaS model delivers a computing platform that can include an operating system, programming language execution environment, database, and web server. Application developers can develop and run their software solutions on the compute service provider platform without the cost of buying and managing the underlying hardware and software. The SaaS model allows installation and operation of application software in the compute service provider. In some embodiments, end users access the compute service provider 400 using networked client devices, such as desktop computers, laptops, tablets, smartphones, etc. running web browsers or other lightweight client applications. Those skilled in the art will recognize that the compute service provider 400 can be described as a “cloud” environment.

In some implementations of the disclosed technology, the computer service provider 500 can be a cloud provider network. A cloud provider network (sometimes referred to simply as a “cloud”) refers to a pool of network-accessible computing resources (such as compute, storage, and networking resources, applications, and services), which may be virtualized or bare-metal. The cloud can provide convenient, on-demand network access to a shared pool of configurable computing resources that can be programmatically provisioned and released in response to customer commands. These resources can be dynamically provisioned and reconfigured to adjust to variable load. Cloud computing can thus be considered as both the applications delivered as services over a publicly accessible network (e.g., the Internet, a cellular communication network) and the hardware and software in cloud provider data centers that provide those services.

With cloud computing, instead of buying, owning, and maintaining their own data centers and servers, organizations can acquire technology such as compute power, storage, databases, and other services on an as-needed basis. The cloud provider network can provide on-demand, scalable computing platforms to users through a network, for example allowing users to have at their disposal scalable “virtual computing devices” via their use of the compute servers and block store servers. These virtual computing devices have attributes of a personal computing device including hardware (various types of processors, local memory, random access memory (“RAM”), hard-disk and/or solid state drive (“SSD”) storage), a choice of operating systems, networking capabilities, and pre-loaded application software. Each virtual computing device may also virtualize its console input and output (“I/O”) (e.g., keyboard, display, and mouse). This virtualization allows users to connect to their virtual computing device using a computer application such as a browser, application programming interface, software development kit, or the like, in order to configure and use their virtual computing device just as they would a personal computing device. Unlike personal computing devices, which possess a fixed quantity of hardware resources available to the user, the hardware associated with the virtual computing devices can be scaled up or down depending upon the resources the user requires. Users can choose to deploy their virtual computing systems to provide network-based services for their own use and/or for use by their customers or clients.

A cloud provider network can be formed as a number of regions, where a region is a separate geographical area in which the cloud provider clusters data centers. Each region can include two or more availability zones connected to one another via a private high-speed network, for example a fiber communication connection. An availability zone (also known as an availability domain, or simply a “zone”) refers to an isolated failure domain including one or more data center facilities with separate power, separate networking, and separate cooling from those in another availability zone. A data center refers to a physical building or enclosure that houses and provides power and cooling to servers of the cloud provider network. Preferably, availability zones within a region are positioned far enough away from one other that the same natural disaster should not take more than one availability zone offline at the same time. Customers can connect to availability zones of the cloud provider network via a publicly accessible network (e.g., the Internet, a cellular communication network) by way of a transit center (TC). TCs are the primary backbone locations linking customers to the cloud provider network and may be collocated at other network provider facilities (e.g., Internet service providers, telecommunications providers) and securely connected (e.g. via a VPN or direct connection) to the availability zones. Each region can operate two or more TCs for redundancy. Regions are connected to a global network which includes private networking infrastructure (e.g., fiber connections controlled by the cloud provider) connecting each region to at least one other region. The cloud provider network may deliver content from points of presence outside of, but networked with, these regions by way of edge locations and regional edge cache servers. This compartmentalization and geographic distribution of computing hardware enables the cloud provider network to provide low-latency resource access to customers on a global scale with a high degree of fault tolerance and stability.

The cloud provider network may implement various computing resources or services that implement the disclosed techniques for TLS session management, which may include an elastic compute cloud service (referred to in various implementations as an elastic compute service, a virtual machines service, a computing cloud service, a compute engine, or a cloud compute service), data processing service(s) (e.g., map reduce, data flow, and/or other large scale data processing techniques), data storage services (e.g., object storage services, block-based storage services, or data warehouse storage services) and/or any other type of network based services (which may include various other types of storage, processing, analysis, communication, event handling, visualization, and security services not illustrated). The resources required to support the operations of such services (e.g., compute and storage resources) may be provisioned in an account associated with the cloud provider, in contrast to resources requested by users of the cloud provider network, which may be provisioned in user accounts.

The particular illustrated compute service provider 400 includes a plurality of server computers 402A-402D. While only four server computers are shown, any number can be used, and large centers can include thousands of server computers. The server computers 402A-402D can provide computing resources for executing software instances 406A-406D. In one embodiment, the instances 406A-406D are virtual machines. As known in the art, a virtual machine is an instance of a software implementation of a machine (i.e. a computer) that executes applications like a physical machine. In the example of virtual machine, each of the servers 402A-402D can be configured to execute a hypervisor 408 or another type of program configured to enable the execution of multiple instances 406 on a single server. Additionally, each of the instances 406 can be configured to execute one or more applications.

It should be appreciated that although the embodiments disclosed herein are described primarily in the context of virtual machines, other types of instances can be utilized with the concepts and technologies disclosed herein. For instance, the technologies disclosed herein can be utilized with storage resources, data communications resources, and with other types of computing resources. The embodiments disclosed herein might also execute all or a portion of an application directly on a computer system without utilizing virtual machine instances.

One or more server computers 404 can be reserved for executing software components for managing the operation of the server computers 402 and the instances 406. For example, the server computer 404 can execute a management component 410. A customer can access the management component 410 to configure various aspects of the operation of the instances 406 purchased by the customer. For example, the customer can purchase, rent or lease instances and make changes to the configuration of the instances. The customer can also specify settings regarding how the purchased instances are to be scaled in response to demand. The management component can further include a policy document to implement customer policies. An auto scaling component 412 can scale the instances 406 based upon rules defined by the customer. In one embodiment, the auto scaling component 412 allows a customer to specify scale-up rules for use in determining when new instances should be instantiated and scale-down rules for use in determining when existing instances should be terminated. The auto scaling component 412 can consist of a number of subcomponents executing on different server computers 402 or other computing devices. The auto scaling component 412 can monitor available computing resources over an internal management network and modify resources available based on need.

A deployment component 414 can be used to assist customers in the deployment of new instances 406 of computing resources. The deployment component can have access to account information associated with the instances, such as who is the owner of the account, credit card information, country of the owner, etc. The deployment component 414 can receive a configuration from a customer that includes data describing how new instances 406 should be configured. For example, the configuration can specify one or more applications to be installed in new instances 406, provide scripts and/or other types of code to be executed for configuring new instances 406, provide cache logic specifying how an application cache should be prepared, and other types of information. The deployment component 414 can utilize the customer-provided configuration and cache logic to configure, prime, and launch new instances 406. The configuration, cache logic, and other information may be specified by a customer using the management component 410 or by providing this information directly to the deployment component 414. The instance manager can be considered part of the deployment component.

Customer account information 415 can include any desired information associated with a customer of the multi-tenant environment. For example, the customer account information can include a unique identifier for a customer, a customer address, billing information, licensing information, customization parameters for launching instances, scheduling information, auto-scaling parameters, previous IP addresses used to access the account, etc.

A network 430 can be utilized to interconnect the server computers 402A-402D and the server computer 404. The network 430 can be a local area network (LAN) and can be connected to a Wide Area Network (WAN) 440 so that end users can access the compute service provider 400. It should be appreciated that the network topology illustrated in FIG. 4 has been simplified and that many more networks and networking devices can be utilized to interconnect the various computing systems disclosed herein.

As shown at 450, the state machine service 250 can execute on a server computer similar to the server computers 402, and can access the rules database 254. Additionally, the health check service 252 and physical store service 256 can execute as instances 406 on one or more server computers 402.

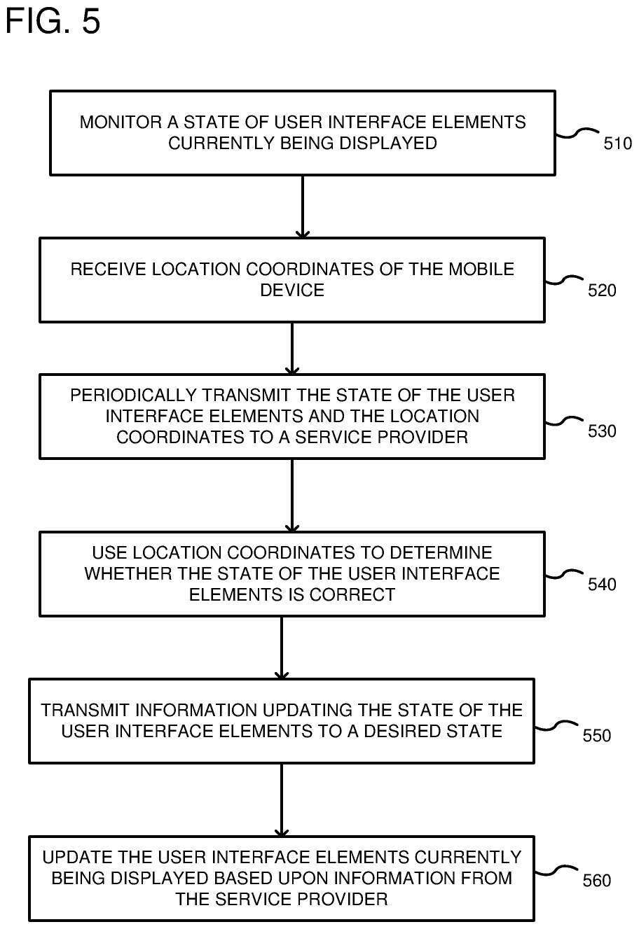

FIG. 5 is a flowchart according to one embodiment for monitoring and correcting UI elements that are displayed. In process block 510, a state of the user interface elements currently being displayed can be monitored. For example, in FIG. 2, the state machine module 242 receives UI elements being displayed on the mobile device from the rendering module 240. In process block 520, location coordinates of the mobile device are received. For example, in FIG. 2, the state machine module 242 receives the location coordinates (e.g., latitude and longitude) from the mobile location service 230, which can include GPS tracking hardware. In process block 530, the state of the user interface elements and the location coordinates is periodically transmitted to a service provider. For example, in FIG. 2, the state machine module 242 can use the wireless modem 228 to transmit the state of the user interface elements and location coordinates to the state machine service 250. In process block 540, the location coordinates are used to determine whether the current state of the UI elements is correct. For example, in FIG. 2, the health check service 252 uses the UI rules 254 and the physical store service 256 to determine whether the location of the mobile device 210 is in or near a physical store of interest (e.g., a particular store brand). If so, then the desired UI elements change based upon location and the actual UI elements being displayed on the mobile device 210 can be compared to the desired UI elements, which are in accordance with the UI rules. In process block 550, the state of the UI elements can be updated. For example, in FIG. 2, the state machine service 250 can transmit an action request, such as updating the UI elements, to the state machine module 242. Finally, in process block 560, the user interface elements on the mobile device are updated in accordance with the information provided by the service provider. For example, in FIG. 2, the state machine 242 can receive an action to perform from the state machine service 250 and perform the action, such as by instructing the refresh module 260 to insert a UI element into what is being displayed.

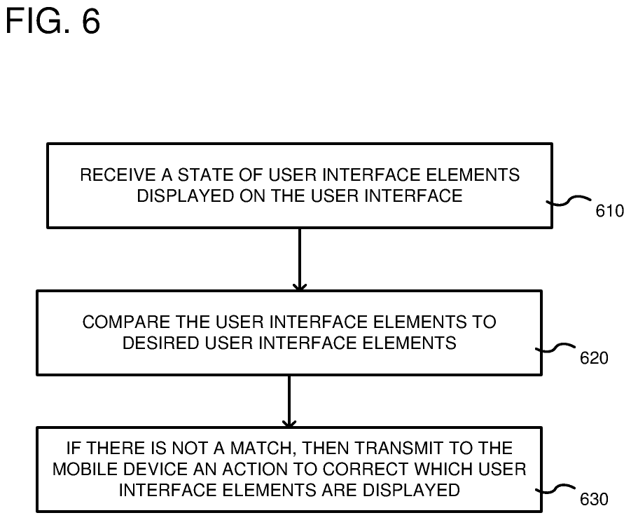

FIG. 6 is a flowchart according to another embodiment for monitoring and correcting what is being displayed on a GUI. In process block 610, a state of user interface elements being displayed is received from a mobile device. For example, the cloud services 220 can receive the state of the user interface elements from the state machine module 242. In process block 620, the user interface elements that were received are compared to desired user interface elements. For example, in FIG. 2, the health check service 252 can compare the received state against a desired state. In some cases, geolocation can be used. In other cases, geolocation need not be used. In process block 630, if there is a mismatch between the actual UI elements and the desired UI elements, then an action can be transmitted to correct the UI elements that are displayed. For example, the state machine module 242 can ensure that the proper UI elements are supplied to the refresh module 260.

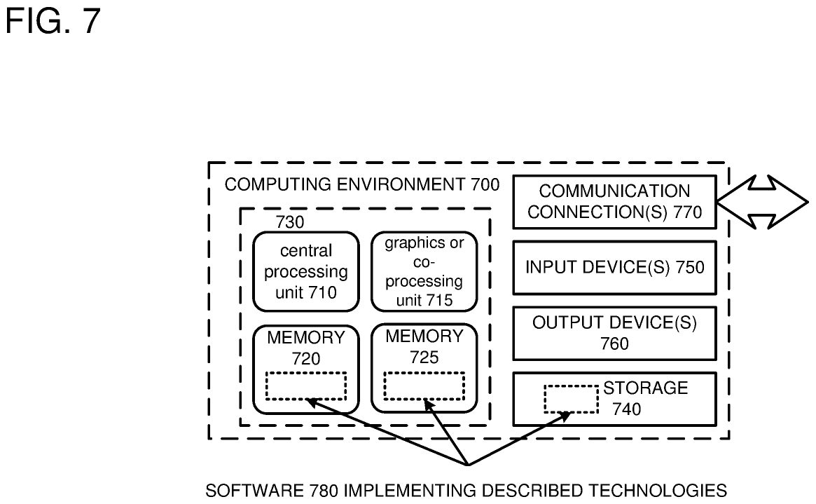

FIG. 7 depicts a generalized example of a suitable computing environment 700 in which the described innovations may be implemented. The computing environment 700 is not intended to suggest any limitation as to scope of use or functionality, as the innovations may be implemented in diverse general-purpose or special-purpose computing systems. For example, the computing environment 700 can be any of a variety of computing devices (e.g., desktop computer, laptop computer, server computer, tablet computer, mobile phone, etc.). Thus, the computing environment 700 can be associated with the mobile device 110 or a service executing in the cloud services 160.

With reference to FIG. 7, the computing environment 700 includes one or more processing units 710, 715 and memory 720, 725. In FIG. 7, this basic configuration 730 is included within a dashed line. The processing units 710, 715 execute computer-executable instructions. A processing unit can be a general-purpose central processing unit (CPU), processor in an application-specific integrated circuit (ASIC) or any other type of processor. In a multi-processing system, multiple processing units execute computer-executable instructions to increase processing power. For example, FIG. 7 shows a central processing unit 710 as well as a graphics processing unit or co-processing unit 715. The tangible memory 720, 725 may be volatile memory (e.g., registers, cache, RAM), non-volatile memory (e.g., ROM, EEPROM, flash memory, etc.), or some combination of the two, accessible by the processing unit(s). The memory 720, 725 stores software 780 implementing one or more innovations described herein, in the form of computer-executable instructions suitable for execution by the processing unit(s).

A computing system may have additional features. For example, the computing environment 700 includes storage 740, one or more input devices 750, one or more output devices 760, and one or more communication connections 770. An interconnection mechanism (not shown) such as a bus, controller, or network interconnects the components of the computing environment 700. Typically, operating system software (not shown) provides an operating environment for other software executing in the computing environment 700, and coordinates activities of the components of the computing environment 700.

The tangible storage 740 may be removable or non-removable, and includes magnetic disks, magnetic tapes or cassettes, CD-ROMs, DVDs, or any other medium which can be used to store information in a non-transitory way and which can be accessed within the computing environment 700. The storage 740 stores instructions for the software 780 implementing one or more innovations described herein.

The input device(s) 750 may be a touch input device such as a keyboard, mouse, pen, or trackball, a voice input device, a scanning device, or another device that provides input to the computing environment 700. The output device(s) 760 may be a display, printer, speaker, CD-writer, or another device that provides output from the computing environment 700.

The communication connection(s) 770 enable communication over a communication medium to another computing entity. The communication medium conveys information such as computer-executable instructions, audio or video input or output, or other data in a modulated data signal. A modulated data signal is a signal that has one or more of its characteristics set or changed in such a manner as to encode information in the signal. By way of example, and not limitation, communication media can use an electrical, optical, RF, or other carrier.

Although the operations of some of the disclosed methods are described in a particular, sequential order for convenient presentation, it should be understood that this manner of description encompasses rearrangement, unless a particular ordering is required by specific language set forth below. For example, operations described sequentially may in some cases be rearranged or performed concurrently. Moreover, for the sake of simplicity, the attached figures may not show the various ways in which the disclosed methods can be used in conjunction with other methods.

Any of the disclosed methods can be implemented as computer-executable instructions stored on one or more computer-readable storage media (e.g., one or more optical media discs, volatile memory components (such as DRAM or SRAM), or non-volatile memory components (such as flash memory or hard drives)) and executed on a computer (e.g., any commercially available computer, including smart phones or other mobile devices that include computing hardware). The term computer-readable storage media does not include communication connections, such as signals and carrier waves. Any of the computer-executable instructions for implementing the disclosed techniques as well as any data created and used during implementation of the disclosed embodiments can be stored on one or more computer-readable storage media. The computer-executable instructions can be part of, for example, a dedicated software application or a software application that is accessed or downloaded via a web browser or other software application (such as a remote computing application). Such software can be executed, for example, on a single local computer (e.g., any suitable commercially available computer) or in a network environment (e.g., via the Internet, a wide-area network, a local-area network, a client-server network (such as a cloud computing network), or other such network) using one or more network computers.

For clarity, only certain selected aspects of the software-based implementations are described. Other details that are well known in the art are omitted. For example, it should be understood that the disclosed technology is not limited to any specific computer language or program. For instance, aspects of the disclosed technology can be implemented by software written in C++, Java, Perl, any other suitable programming language. Likewise, the disclosed technology is not limited to any particular computer or type of hardware. Certain details of suitable computers and hardware are well known and need not be set forth in detail in this disclosure.

It should also be well understood that any functionality described herein can be performed, at least in part, by one or more hardware logic components, instead of software. For example, and without limitation, illustrative types of hardware logic components that can be used include Field-programmable Gate Arrays (FPGAs), Program-specific Integrated Circuits (ASICs), Program-specific Standard Products (ASSPs), System-on-a-chip systems (SOCs), Complex Programmable Logic Devices (CPLDs), etc.

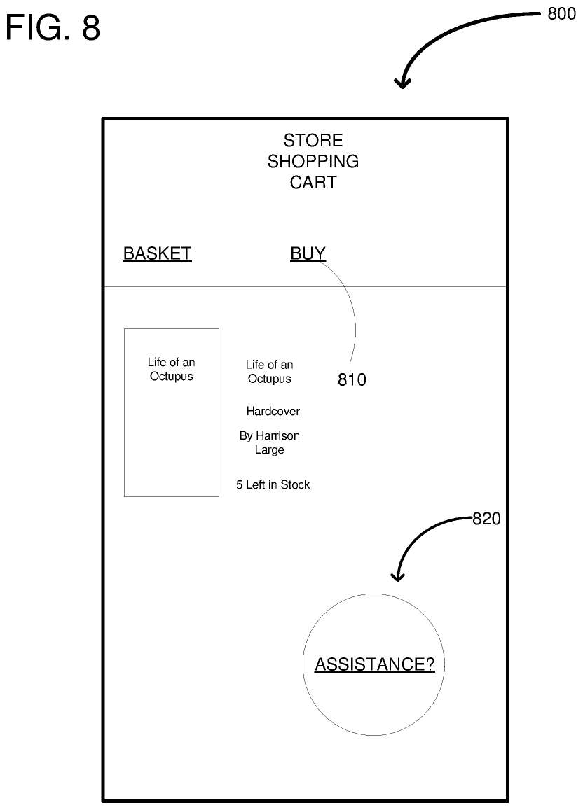

FIG. 8 is an example electronic shopping cart 800, wherein selectable user interface elements are shown underlined (see 810, for example) to indicate that they can be clicked to invoke an action to be performed. An assistance button 820 can be selected by a user if any UI elements are missing from the UI or incorrect UI elements are displayed. For example, if the “buy” button is not present, the user can select the assistance button 820 asking for the display to reset. When the assistance button 820 is selected, the user interface elements currently being displayed are transmitted to the cloud provider, as described above, which can review what is being displayed and update the display accordingly.

Furthermore, any of the software-based embodiments (comprising, for example, computer-executable instructions for causing a computer to perform any of the disclosed methods) can be uploaded, downloaded, or remotely accessed through a suitable communication means. Such suitable communication means include, for example, the Internet, the World Wide Web, an intranet, software applications, cable (including fiber optic cable), magnetic communications, electromagnetic communications (including RF, microwave, and infrared communications), electronic communications, or other such communication means.

The disclosed methods, apparatus, and systems should not be construed as limiting in any way. Instead, the present disclosure is directed toward all novel and nonobvious features and aspects of the various disclosed embodiments, alone and in various combinations and subcombinations with one another. The disclosed methods, apparatus, and systems are not limited to any specific aspect or feature or combination thereof, nor do the disclosed embodiments require that any one or more specific advantages be present or problems be solved.

In view of the many possible embodiments to which the principles of the disclosed invention may be applied, it should be recognized that the illustrated embodiments are only examples of the invention and should not be taken as limiting the scope of the invention. We therefore claim as our invention all that comes within the scope of these claims.

What is claimed is:

1. One or more computer-readable media comprising computer-executable instructions that, when executed, cause one or more computing systems to perform a method comprising:
in an application executing on a mobile device, monitoring a state of user interface elements currently being displayed;
receiving location coordinates of the mobile device;
periodically transmitting the state of the user interface elements and the location coordinates to a service provider;
at the service provider, using the location coordinates to determine whether the state of the user interface elements is correct;
transmitting, to the mobile device from the service provider, information updating the state of the user interface elements to a desired state; and
updating the user interface elements currently being displayed in the application on the mobile device based upon the information received from the service provider.

2. The one or more computer-readable media of claim 1, wherein the instructions, upon execution, further cause the one or more computing systems to: determine whether the mobile device is within a store of interest and wherein whether or not the state of the user interface elements is correct depends upon whether the mobile device is within the store of interest.

3. The one or more computer-readable media of claim 1, wherein the instructions, upon execution, further cause the one or more computing systems to: transmit a scroll height to the service provider indicating a state of scrolling on the user interface.

4. The one or more computer-readable media of claim 1, wherein the instructions, upon execution, further cause the one or more computing systems to: receive the location coordinates a from a GPS receiver or from a Wi-Fi receiver.

5. The one or more computer-readable media of claim 1, wherein the instructions, upon execution, further cause the one or more computing systems to: display a user interface button that allows a user to control the updating of the user interface elements.

6. A method of correcting what is displayed on a user interface, the method comprising:
receiving, at a service provider, from a mobile device, a state of user interface elements displayed on the user interface of the mobile device;
receiving, from the mobile device, a location of the mobile device;
comparing the user interface elements displayed on the user interface to desired user interface elements based upon rules stored at the service provider, wherein the rules include using the location of the mobile device; and
if the desired user interface elements do not match the user interface elements displayed on the user interface, then transmitting to the mobile device an action to correct what is displayed on the user interface by matching the user interface elements displayed to the desired user interface elements.

7. The method of claim 6, wherein the location is received from a GPS receiver or from a Wi-Fi receiver.

8. The method of claim 7, further including comparing the location to a location of a store and wherein the desired user interface elements change based upon whether the location of the mobile device matches the location of the store.

9. The method of claim 6, wherein the action includes transmitting an instruction to display a button requesting whether there is a problem with the user interface elements being displayed and receiving a selection of the button.

10. The method of claim 6, further including, receiving periodically, from the mobile phone, the state of the user interface elements being displayed.

11. The method of claim 6, wherein the comparing determines that the user interface is not displaying a user interface element that is supposed to be displayed.

12. The method of claim 6, further including receiving, from the mobile device, a scrolling height indicating a state of scrolling on the user interface.

13. The method of claim 6, further including receiving from a state machine on the mobile device, the state of the user interface elements being displayed on the user interface and transmitting the state periodically to the service provider.

14. The method of claim 6, wherein the user interface elements are selectable links being displayed to the user to navigate within an application executing on the mobile device.

15. One or more computer-readable media comprising computer-executable instructions that, when executed, cause a computing system to perform a method comprising:
transmitting information indicative of a location of a mobile device to a service provider;
receiving, from the service provider, instructions to produce a user interface including one or more user interface elements that are dependent on the location;
executing, in an application on a mobile device, a state machine that captures information associated with which user interface elements are active in the application;
transmitting the information associated with the user interface elements to the service provider indicating which of the user interface elements are active in the application;
receiving revised instructions to produce one or more user interface elements that should have been active but were not detected as active by the state machine; and
executing the revised instructions updating the user interface elements in accordance with the received instructions.

16. The one or more computer-readable media of claim 15, wherein the instructions, upon execution, further cause the computing system to: receive the information indicative of the location from a GPS receiver or Wi-Fi.

17. The one or more computer-readable media of claim 16, wherein the instructions, upon execution, further cause the computing system to: determine whether the mobile device is within a store and compare the information associated with the user interface elements to stored information based upon whether the mobile device is within the store.

18. The one or more computer-readable media of claim 15, wherein the instructions, upon execution, further cause the computing system to: capture, in the state machine, a scrolling height associated with the user interface.

19. The one or more computer-readable media of claim 15, wherein the instructions, upon execution, further cause the computing system to: transmit the information associated with the user interface elements at fixed time intervals.

20. The one or more computer-readable media of claim 15, wherein the instructions, upon execution, further cause the computing system to: display a button requesting whether there is a problem with the user interface elements being displayed.
